(19) United States
(12) Patent Application Publication
(10) Pub. No.: US 2018/0111533 A1
(43) Pub. Date: Apr. 26, 2018

(54) Food Tray System

(71) Applicant: Robert Johnson, JR., East Haven, CT (US)

(72) Inventor: Robert Johnson, JR., East Haven, CT (US)

(21) Appl. No.: 15/299,895

(22) Filed: Oct. 21, 2016

(51) Int. Cl. B60N 3/00

(52) U.S. Cl. CPC B60N 3/004; B60N 2002/4405

(57) ABSTRACT

A food tray system includes a vehicle that has at least one seat. A supporting unit is removably supported on the at least one seat. The supporting unit may support food items thereby facilitating the food items to be consumed in the vehicle. A pair of straps is provided and each of the straps is coupled to the supporting unit. Each of the straps removably engages the at least one seat such that the supporting unit is removably supported on the seat.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIE THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98

The disclosure and prior art relates to tray devices and more particularly pertains to a new tray device for facilitating food to be consumed in a vehicle.

### BRIEF SUMMARY OF THE INVENTION

An embodiment of the disclosure meets the needs presented above by generally comprising a vehicle that has at least one seat. A supporting unit is removably supported on the at least one seat. The supporting unit may support food items thereby facilitating the food items to be consumed in the vehicle. A pair of straps is provided and each of the straps is coupled to the supporting unit. Each of the straps removably engages the at least one seat such that the supporting unit is removably supported on the seat.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective in—use view of a food tray system according to an embodiment of the disclosure.

FIG. 2 is a right side view of an embodiment of the disclosure in a deployed position.

FIG. 3 is a right side view of an embodiment of the disclosure in a stored position.

FIG. 4 is a top view of an embodiment of the disclosure.

FIG. 5 is a front view of an embodiment of the disclosure.

### DETAILED DESCRIPTION OF THE INVENTION

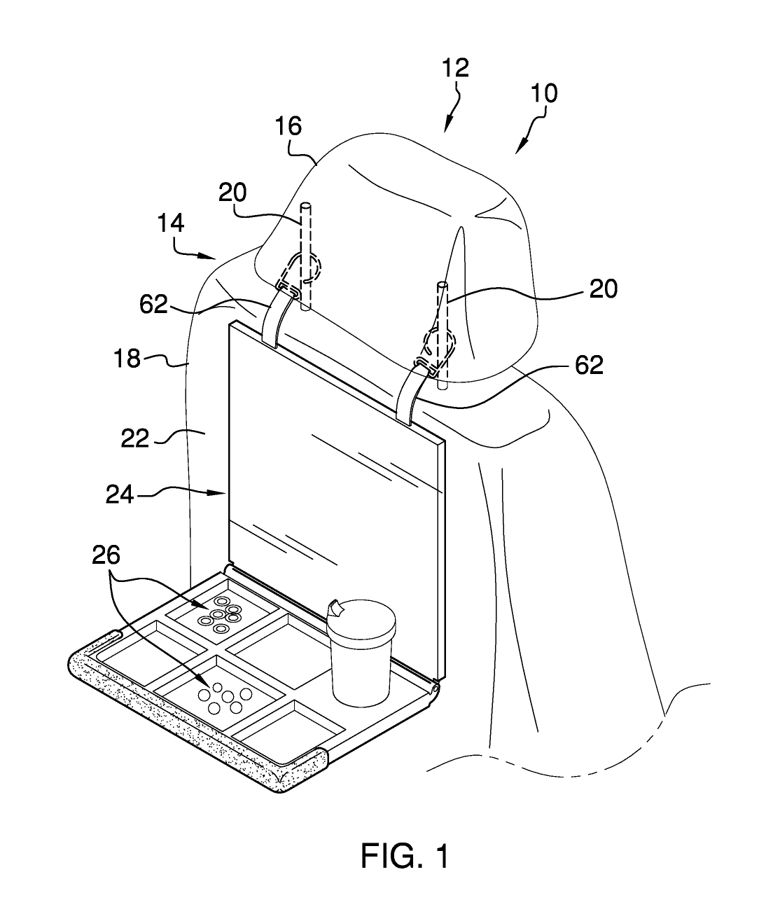

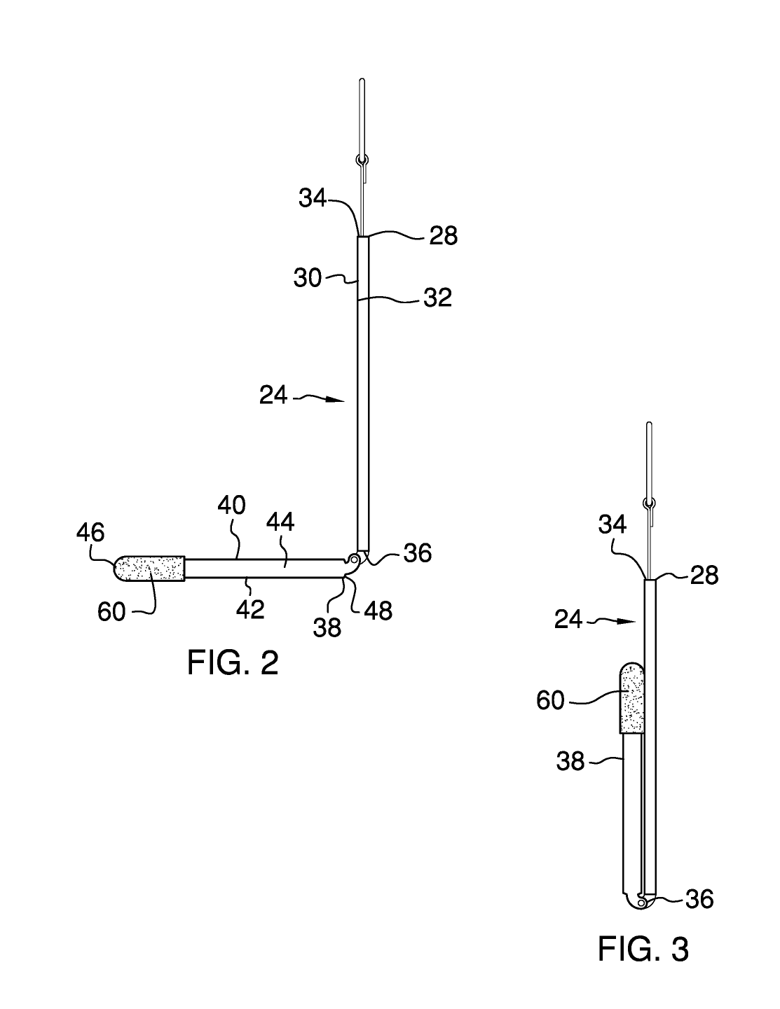

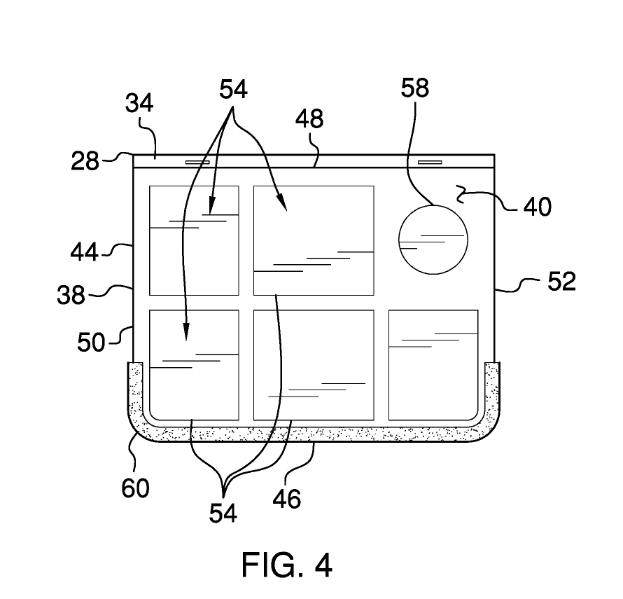

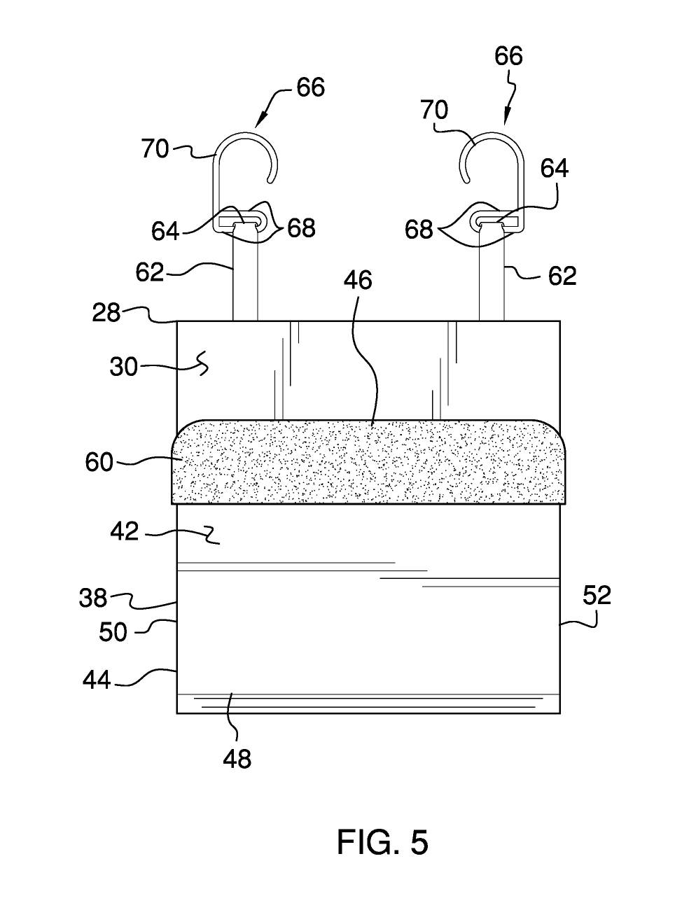

With reference now to the drawings, and in particular to FIGS. 1 through 5 thereof, a new tray device embodying the principles and concepts of an embodiment of the disclosure and generally designated by the reference numeral 10 will be described.

As best illustrated in FIGS. 1 through 5, the food tray system 10 generally comprises a vehicle 12 that has at least one seat 14. The at least one seat 14 has a head rest 16 and a chair 18. The head rest 16 includes a pair of posts 20 extending between the head rest 16 and the chair 18. The chair 18 has a back side 22. The vehicle 12 may be a passenger vehicle 12 or the like. The at least one seat 14 may be a front seat in the vehicle 12. Moreover, the vehicle 12 may include a back seat.

A supporting unit 24 is provided and the supporting unit 24 is removably supported on the at least one seat 14. The supporting unit 24 may support food items 26 thereby facilitating the food items 26 to be consumed in the vehicle 12. The supporting unit 24 may be positioned on the front seat. Thus, a passenger in the back seat may access the supporting unit 24 to consume the food items 26. The passenger in the back seat may be a child.

The supporting unit 24 comprises a panel 28 that has a first surface 30 and a peripheral edge 32. The peripheral edge 32 has a top side 34 and a bottom side 36. The panel 28 is positioned on the back side 22 of the chair 18. Thus, the first surface 30 is exposed.

A tray 38 is provided and the tray 38 is hingedly coupled to the panel 28. The tray 38 has a primary surface 40, a secondary surface 42 and a perimeter edge 44 extending therebetween. The perimeter edge 44 has a front side 46, a back side 48, a first lateral side 50 and a second lateral side 52. The primary surface 40 has a plurality of wells 54 extending downwardly therein. Thus, each of the wells 54 may have food items 26 positioned therein.

The wells 54 are spaced apart from each other and are distributed on the primary surface 40. The plurality of wells 54 may include a set of first wells 56 and a second well 58. Each of the first wells 56 may have a square shape. The second well 58 may have a circular shape. Thus, the second well 58 may receive a beverage container or the like.

The back side 22 of the tray 38 is hingedly coupled to the bottom side 36 of the panel 28. The tray 38 is positioned in a deployed position having the primary surface 40 lying on a horizontal plane. The tray 38 is positioned in a stored position having the primary surface 40 of the tray 38 abutting the first surface 30 of the panel 28. The tray 38 may include a hinge and the hinge may retain the tray 38 in the horizontal orientation when the tray 38 is positioned in the deployed position.

A cushion 60 is provided and the cushion 60 is coupled to the front side 46 of the tray 38. The cushion 60 extends substantially along each of the first lateral side 50 and the second lateral side 52 of the tray 38. The cushion 60 is comprised of a resiliently compressible material. Thus, the cushion 60 may inhibit the passenger from being injured by the tray 38 in a vehicular accident when the tray 38 is in the deployed position. The cushion 60 may extend substantially along the secondary surface 42 of the tray 38.

A pair of straps 62 is provided and each of the straps 62 is coupled to the supporting unit 24. Each of the straps 62 removably engages the at least one seat 14. Thus, the supporting unit 24 is removably supported on the seat. Each of the straps 62 is coupled to the top side 34 of the panel 28 and the straps 62 are spaced apart from each other. Each of the straps 62 has a distal end 64 with respect to the panel 28.

A pair of hooks 66 is provided and each of the hooks 66 has a pair of lateral members 68. The lateral members 68 corresponding to each of the hooks 66 are spaced apart from each other. Each of the hooks 66 has a grapple 70 that is coupled to and extends upwardly from an associated one of the lateral members 68. The grapple 70 corresponding to each of the hooks 66 is curved downwardly toward the associated lateral member 68. The distal end 64 of an associated one of the straps 62 is coupled to an associated one of the lateral members 68 of an associated one of the hooks 66. The grapple 70 corresponding to each of the hooks 66 engages an associated one of the posts 20 on the head rest 16. Thus, the supporting unit 24 is supported on the back side 22 of the chair 18.

In use, each of the hooks 66 is positioned to engage the associated post 20 on the head rest 16. Thus, the supporting unit 24 is suspended on the back side 22 of the chair 18. The tray 38 is selectively placed in the deployed position. The food items 26 are positioned in the wells 54. The passenger sits in the back seat of the vehicle 12 and consumes the food items 26. The tray 38 inhibits the food items 26 from spilling in the vehicle 12 and soiling the vehicle 12. The tray 38 is positioned in the stored position when the food items 26 are consumed.

With respect to the above description then, it is to be realized that the optimum dimensional relationships for the parts of an embodiment enabled by the disclosure, to include variations in size, materials, shape, form, function and manner of operation, system and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A food tray system comprising:
a vehicle having at least one seat;
a supporting unit being removably supported on said at least one seat, said supporting unit being configured to support food items thereby facilitating the food items to be consumed in said vehicle; and
a pair of straps, each of said straps being coupled to said supporting unit, each of said straps removably engaging said at least one seat such that said supporting unit is removably supported on said seat.

2. The system according to claim 1, wherein said at least one seat has a head rest and a chair, said head rest including a pair of posts extending between said head rest and said chair, said chair having a back side.

3. The system according to claim 2, wherein said supporting unit comprises a panel having a first surface and a peripheral edge, said peripheral edge having a top side and a bottom side, said panel being positioned on said back side of said chair having said first surface being exposed.

4. The system according to claim 3, further comprising a tray being hingedly coupled to said panel, said tray having a primary surface and a perimeter edge, said perimeter edge having a front side, a back side, a first lateral side and a second lateral side, said primary surface having a plurality of wells extending downwardly therein wherein each of said wells is configured to have food items positioned therein, said wells being spaced apart from each other and being distributed on said primary surface, said back side of said tray being hingedly coupled to said bottom side of said panel, said tray being positioned in a deployed position having said primary surface lying on a horizontal plane, said tray being positioned in a stored position having said primary surface of said tray abutting said first surface of said panel.

5. The system according to claim 4, further comprising a cushion being coupled to said front side of said tray, said cushion extending substantially along each of said first lateral side and said second lateral side of said tray, said cushion being comprised of a resiliently compressible material wherein said cushion is configured to inhibit a user from being injured by said tray in a vehicular accident when said tray is in said deployed position.

6. The system according to claim 3, wherein each of said straps is coupled to said top side of said panel, said straps being spaced apart from each other, each of said straps having a distal end with respect to said panel.

7. The system according to claim 1, further comprising a pair of hooks, each of said hooks having a pair of lateral members, said lateral members corresponding to each of said hooks being spaced apart from each other, each of said hooks having a grapple being coupled to and extending upwardly from an associated one of said lateral members, said grapple corresponding to each of said hooks being curved downwardly toward said associated lateral member.

8. The system according to claim 7, wherein:
each of said straps has a distal end;
said at least one seat has a head rest and a chair, said chair having a back side, said head rest having a pair of posts; and
said distal end of an associated one of said straps being coupled to an associated one of said lateral members of an associated one of said hooks, said grapple corresponding to each of said hooks engaging an associated one of said posts on said head rest such that said supporting unit is supported on said back side of said chair.

9. A food tray system comprising:
a vehicle having at least one seat, said at least one seat having a head rest and a chair, said head rest including a pair of posts extending between said head rest and said chair, said chair having a back side;
a supporting unit being removably supported on said at least one seat, said supporting unit being configured to support food items thereby facilitating the food items to be consumed in said vehicle, said supporting unit comprising:
a panel having a first surface and a peripheral edge, said peripheral edge having a top side and a bottom side, said panel being positioned on said back side of said chair having said first surface being exposed;
a tray being hingedly coupled to said panel, said tray having a primary surface and a perimeter edge, said perimeter edge having a front side, a back side, a first lateral side and a second lateral side, said primary surface having a plurality of wells extending downwardly therein wherein each of said wells is configured to have food items positioned therein, said wells being spaced apart from each other and being distributed on said primary surface, said back side of said tray being hingedly coupled to said bottom side of said panel, said tray being positioned in a deployed position having said primary surface lying on a horizontal plane, said tray being positioned in a stored position having said primary surface of said tray abutting said first surface of said panel; and
a cushion being coupled to said front side of said tray, said cushion extending substantially along each of said first lateral side and said second lateral side of said tray, said cushion being comprised of a resiliently compressible material wherein said cushion is configured to inhibit a user from being injured by said tray in a vehicular accident when said tray is in said deployed position; and
a pair of straps, each of said straps being coupled to said supporting unit, each of said straps removably engaging said at least one seat such that said supporting unit is removably supported on said seat, each of said straps being coupled to said top side of said panel, said straps being spaced apart from each other, each of said straps having a distal end with respect to said panel; and
a pair of hooks, each of said hooks having a pair of lateral members, said lateral members corresponding to each of said hooks being spaced apart from each other, each of said hooks having a grapple being coupled to and extending upwardly from an associated one of said lateral members, said grapple corresponding to each of said hooks being curved downwardly toward said associated lateral member, said distal end of an associated one of said straps being coupled to an associated one of said lateral members of an associated one of said hooks, said grapple corresponding to each of said hooks engaging an associated one of said posts on said head rest such that said supporting unit is supported on said back side of said chair.
